(19) United States
(12) Patent Application Publication
(10) Pub. No.: US 2025/0307955 A1
(43) Pub. Date: Oct. 2, 2025

(54) AI-DRIVEN JOURNAL/STORY-BASED MATCHMAKING SYSTEM WITH INTENT-BASED CHAPTER SWIPING FOR DEEP EMOTIONAL COMPATIBILITY

(71) Applicant: Gowtham Manivelan, Chicago, IL (US)

(72) Inventor: Gowtham Manivelan, Chicago, IL (US)

(21) Appl. No.: 19/098,536

(22) Filed: Apr. 2, 2025

Related U.S. Application Data
(60) Provisional application No. 63/573,180, filed on Apr. 2, 2024.

(51) Int. Cl. G06Q 50/00

(52) U.S. Cl. CPC G06Q 50/01

(57) ABSTRACT

An AI-driven matchmaking system designed around narrative-based user profiles is disclosed. Each user is represented as a digital book comprising thematic categories and expressive chapters. A dual-embedding compatibility engine analyzes self-expressed and preferred traits, enabling bidirectional scoring. Users interact through chapter-level swiping and engage in milestone-triggered emotional messaging. The system promotes reflective authenticity and dynamic compatibility modeling beyond visual-first paradigms.

### CROSS REFERENCE TO RELATED APPLICATION

This application claims the benefit of priority of U.S. provisional application No. 63/573,180, filed 2 Apr. 2024, the contents of which are herein incorporated by reference.

### BACKGROUND OF THE SUBJECT DISCLOSURE

The present invention relates to digital matchmaking services and, more particularly, an AI-driven journal/story/chapter-based matchmaking system with intent-based chapter swiping for deep emotional compatibility.

Digital matchmaking is having a connection crisis, aggravating the growing epidemic of loneliness. Current platforms superficially base connections on physical appearance or minimal information, resulting in shallow interactions that fail to foster genuine, meaningful relationships. This problem is exacerbated in a digital age that, while offering numerous ways to connect, often leaves individuals feeling more disconnected and misunderstood than ever, highlighting a critical need for solutions that can cultivate deeper emotional resonance and understanding among users.

Traditional matchmaking platforms focus on static user profiles, appearance-based swiping, and limited personality insights, leading to shallow, transactional interactions and dating fatigue. These systems fail to capture the depth of human experiences, emotions, and relationship goals, contributing to a wider connection crisis and increasing social isolation. Additionally, modern dating apps do not encourage self-awareness, self-expression, or emotional growth-users are reduced to profiles rather than seen as evolving individuals. There is no structured way for users to reveal their depth progressively, build self-confidence, or understand their own relationship needs over time. The subject disclosure solves these challenges by introducing a journal/story-based matchmaking system where each user is represented as a book, and they write chapters about different aspects of their life. Terminology Clarification: As used herein, “chapters” (or “chapter entries”) may also be referred to, in some embodiments, as “journal entries,” “story entries,” or other structurally similar forms of user-submitted narrative content. Consequently, a “journal-based” approach is inherently encompassed by the “chapter-based” approach described in this system. Whether the user interface labels them “chapters,” “journals,” or “stories,” the invention's core method of progressive, thematically structured self-expression, dynamic AI analysis, and compatibility scoring remains the same.

These chapters serve as self-reflective prompts that help users articulate their identity, values, relationship expectations, and emotional growth journey. Unlike traditional dating apps where users swipe on static profiles, this system enables “chapter-based swiping”—where users engage with individual chapters of a person's life story rather than making instant judgments based on profile photos. This fosters intent-based connections, deeper engagement, and a more emotionally intelligent approach to matchmaking. Beyond matchmaking, this invention also empowers users with self-awareness, self-reflection, and confidence-building, helping them gain clarity on what they seek in a relationship and what makes them feel truly understood.

Existing matchmaking platforms rely on static user profiles, appearance-based swiping, and rigid algorithmic matching based on superficial preferences, leading to shallow interactions, swiping fatigue, and misaligned expectations. These systems fail to account for the complexity of human emotions, self-growth, and evolving relationship intent, resulting in low-quality matches, ghosting, and a lack of deep emotional resonance. Furthermore, these traditional approaches contribute to a broader social isolation and connection crisis, where people struggle to form meaningful relationships. By prioritizing quick, surface-level engagement over depth and authenticity, these platforms reinforce loneliness, emotional disconnection, and reduce self-awareness, rather than fostering genuine human connection and self-growth.

Traditional matchmaking systems fail because they prioritize instant gratification over meaningful connection, relying on appearance-based swiping and static user profiles that do not evolve with a person's emotional growth or changing relationship needs. These platforms encourage rapid, surface-level interactions, leading to high rates of ghosting, misaligned expectations, and emotional fatigue, while failing to address the deeper connection crisis and rising social isolation in modern society.

Furthermore, current dating apps employ a wide array of prompts and features, such as icebreakers, preference declarations, and gamified interactions, to initiate conversations and match users based on superficial or static criteria. These methods, while diverse, often fall short in fostering deep, meaningful connections as they rely heavily on the user's initial impressions and predetermined preferences. This approach overlooks the dynamic and complex nature of human emotions and personal growth over time, thus limiting the potential for truly authentic and evolving relationships.

These systems fall short because they are unable to adapt to the evolving nature of individual users' lives and emotions. Static profiles and pre-determined matching criteria cannot reflect changes in a user's experiences, growth, or emotional state over time. Consequently, matches made under these systems can lack depth, failing to progress beyond initial attraction or commonalities into the realm of genuine emotional and intellectual compatibility. This results in connections that are fleeting and lack substance, contributing to a cycle of continuous searching without finding truly meaningful relationships.

As can be seen, there is a need for a journal, story or chapter and mood-based algorithm for enhanced emotional connectivity in digital matchmaking. Unlike purely abstract matching methods, the present system provides a technical solution by introducing dynamic data structures and AI-driven embedding mechanisms. This approach reduces server load from repeated superficial queries and instead leverages a structured chapter-based interface that is updated in real-time, improving both the efficiency and accuracy of generating match recommendations. By dynamically adapting compatibility metrics as users add or modify their chapter entries, the system addresses performance bottlenecks of legacy platforms while delivering deeper emotional alignment.

The present invention introduces a sophisticated, multifaceted algorithm that dynamically integrates journal, chapter entries and mood data, offering a real-time, holistic view of each user. Unlike static profiles or superficial matching criteria, this approach supports continuous adaptation of matching parameters to reflect users' current emotional states, interests, and life changes. This method facilitates matches based on emotional resonance and shared life perspectives, so that connections extend beyond initial compatibility and can deepen over time. By prioritizing genuine understanding and emotional alignment, the invention provides a robust and adaptive framework for digital matchmaking, enabling deeper, longer-lasting human connections.

The proprietary matchmaking solution embodied by the present invention leverages an advanced, multifaceted algorithm designed to foster deep, meaningful connections through an innovative integration of journal entries, chapter responses and real-time mood analysis, among a broad spectrum of compatibility factors. This unique system is distinguished by its ability to dynamically adapt based on diverse factors, including user interests, life philosophies, and emotional resonance, thereby providing a robust level of depth in matchmaking. By synthesizing nuanced personal insights and a comprehensive understanding of human connection, our approach establishes a new standard in digital interactions, creating a protected space that competitors cannot replicate without infringing on our distinct methodological and technological framework.

In sum, the matchmaking solution described herein offers a deeply integrated approach to digital connections by combining journal insights, life entries, chapter responses on different categories, personal stories with mood-based analytics. This framework provides a highly personalized and resonant experience in the dating and social networking space, moving beyond traditional, appearance-centric platforms.

In other words, conventional digital dating platforms have historically focused on rapid, low-effort interactions primarily rooted in visual appeal and concise textual prompts. This design leads to reduced authenticity, superficial engagement, and low match quality. Users often experience fatigue, misaligned expectations, and emotionally hollow interactions, resulting in ghosting, mistrust, and premature abandonment of the platform. These systems lack mechanisms for progressive emotional discovery, structured self-expression, or intentional relational design.

Accordingly, there exists a need for a platform that shifts the paradigm from superficial swiping to emotionally intelligent matching-one that fosters self-reflection, structured emotional articulation, and compatibility grounded in values, experiences, and authentic personal narratives. The disclosed invention addresses this need by introducing an AI-powered storytelling system that encodes self-awareness and partner preferences through expressive, chapter-based interaction.

### SUMMARY OF THE SUBJECT DISCLOSURE

In one aspect of the present subject disclosure, the system replaces static profile-based matchmaking with a dynamic, structured chapter-driven system, allowing users to engage with specific aspects of a person's story rather than making instant judgments based on photos or short bios. By introducing chapter-based swiping, users can selectively engage with different life experiences, values, and emotions of potential matches, leading to more meaningful, intent-driven connections. Unlike traditional dating apps that rely on appearance-based swiping, this system encourages progressive self-expression, where users write and reveal chapters of their life, helping both themselves and potential partners understand their evolving emotional journey and relationship goals.

Users write responses to curated chapter prompts designed to reveal different aspects of their personality, emotions, values, and relationship goals. This structured approach ensures deeper, intent-driven matchmaking by allowing users to progressively explore and connect over shared experiences, emotional depth, and evolving relationship intent, making it fundamentally different from appearance-focused platforms.

Additionally, the system leverages AI to analyze language, themes, sentiment, contextual understanding and emotional tone within each chapter, allowing for highly personalized matchmaking based on deep compatibility rather than surface-level traits. As users continue to add new chapters, the system dynamically updates their compatibility insights, refining their match suggestions over time. Beyond matchmaking, this approach also promotes self-awareness, confidence, and personal growth, ensuring that users not only find compatible partners but also gain a deeper understanding of themselves in the process.

In another aspect of the present subject disclosure an AI-driven, chapter-based matchmaking system engages users with structured chapters that reveal their evolving personality, values, and emotional journey. By allowing users to swipe on individual life chapters rather than entire profiles, this system fosters deeper intent-driven connections, reduces ghosting, and combats social isolation by prioritizing meaningful engagement over superficial attraction.

The subject disclosure provides a matchmaking system wherein user profiles are structured as evolving digital books. Each profile begins with a symbolic cover that reflects the user's persona, which may include AI-curated themes, visuals, or introspective expressions. Alongside the book cover, users create a page note—a short piece of text that reflects their current emotional identity or philosophy, serving as an initial touchpoint. Following this is a signature chapter, acting as a reflective entry point, designed to establish early emotional anchoring.

The system embodied in the subject disclosure organizes content into thematic categories (e.g., “Let's Start Here,” “Attraction & Chemistry,” “People & Connections”). Each category houses multiple chapters (e.g., “Get to know me”, “A Day in my life”) and progression is contingent upon completing a minimum threshold of chapters (e.g., 3 of 5). Chapter prompts are structured to move from descriptive to introspective content, thereby engineering a psychological unfolding.

Each chapter supports multiple expressive formats, including storytelling, reverse perspective, empty chair, list and re-rank, and finish-the-sentence. These formats accommodate various psychological expression types.

Completed chapters are parsed through an AI compatibility engine branded ‘AI for Humanity.’ This engine leverages natural language understanding, tone modeling, and context-aware semantic analysis to derive emotional traits and partner preferences. Outputs are encoded into a User Vector and a Partner Preference Vector.

Compatibility is calculated bidirectionally, comparing each user's preferences to the other's identity vector. Scores incorporate tone resonance, shared values, narrative depth, and expressive modality congruence.

Users swipe on individual chapters or chapter bundles, providing emotionally segmented match behavior. Swipes feed back into compatibility recalibration, reinforcing relevance of thematic and emotional alignment.

The Red Envelope feature allows users to send milestone-based emotional messages, which remain locked until certain relational triggers are met (e.g., time, depth of engagement, shared reflection).

In one aspect of the subject disclosure a matchmaking system provides the following: an interface operable to electronically receive a plurality of user profiles, each profile structured as a digital book comprising one or more thematic categories with multiple chapters of a respective user; and electronically receive a first request for matching, the first request electronically submitted by a first user using a first electronic device; a processor coupled to the interface and operable to: determine from the plurality of user profiles a set of preferred partner characteristics for the first user by way of a progression module based on chapter completion thresholds; cause the display of a graphical representation of a first preferred partner based on the set of preferred partner characteristics of the first user on a graphical user interface of the first electronic device, the preferred partner corresponding to one or more thematic categories and relevant digital book chapters of a second user; and wherein the interface is further operable to receive from the first electronic device of the first user a first positive preference indication associated with the graphical representation of the second user on the graphical user interface, the first positive preference indication associated with a swiping gesture performed on the graphical user interface, wherein the gesture comprises a swiping gesture of the one or more thematic categories and relevant digital book chapters of the second user.

In another aspect of the subject disclosure the matchmaking system further provides the following: wherein the processor is further operable so that each chapter supports at least three expressive response formats selected by the user, wherein the processor is further operable to provide a compatibility engine that extracts emotional traits from user responses using natural language understanding and tone analysis, wherein the set of preferred partner characteristics is augmented by the extracted emotional traits, wherein said compatibility engine creates a user vector representing a user's expressed traits and a partner vector representing the user's preferred partner characteristics, wherein compatibility scoring is calculated bidirectionally by comparing each user's preference vector to the other user's trait vector, wherein compatibility scoring incorporates narrative depth, tone resonance, and expressive pattern analysis of the digital book of the preferred partner, wherein the processor is further operative to gate or limit access to subsequent chapter categories based on minimum threshold completions from prior categories, wherein the interface is further operable to enable users to evaluate and select preferred partner matched by interacting with individual or bundled chapters, wherein the interface further is operable to provide swiping feedback updates to said compatibility vectors and thematic interest models, wherein the processor is further operable to comprise a red envelope messaging feature that enables milestone-based emotional communication governed by predefined triggers.

In yet another aspect of the subject disclosure a method for matchmaking includes the following steps: receiving user inputs structured as one or more chapters of a digital book; analyzing said chapters via a large language model to extract emotional or personality traits; storing said traits in a data structure (e.g., a list or graph-based data structure); generating a user vector and a partner vector for each user; comparing user vector of a first user with partner vector of a second user to compute a bidirectional compatibility score; and displaying a recommended match to the first user, wherein the recommended match is a function of said bidirectional compatibility score.

These and other features, aspects and advantages of the present subject disclosure will become better understood with reference to the following drawings, description and claims.

### BRIEF DESCRIPTION OF THE DRAWINGS

FIG. 1 is a schematic view of a Chapter-Based Profile Construction module showing progressive category unlocking, symbolic cover, and expressive chapter formats. Each user initiates the system with a profile structure inspired by the metaphor of a book. The symbolic book cover may reflect the user's identity or mood, while the page note offers an emotional or philosophical snapshot. The first chapter, typically ‘Get to know me’, sets the emotional tone. Chapters are grouped into evolving thematic categories (e.g., ‘Past Lessons’, ‘Emotional Patterns’, ‘Attachment Styles’). Each chapter is format-flexible, with options such as narrative storytelling, role-reversal dialogue, list &re-rank, reverse perspective, or metaphorical labeling. These formats are extensible and designed to allow ongoing expansion. The platform employs a gating mechanism-users must complete a minimum number of chapters within a category to progress. The AI continuously analyzes responses for emotional clarity, tone shifts, and contextually significant themes.

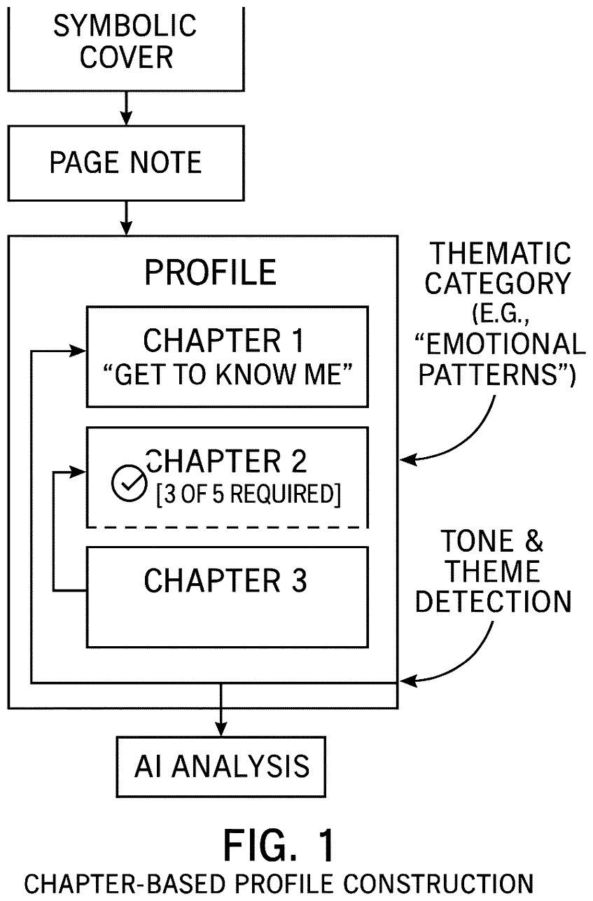

FIG. 2 is a schematic view of a Trait Extraction & Dual Embedding Flow module, demonstrating how structured signals are derived and encoded, specifically outlining the AI trait extraction pipeline using transformer-based NLP, tone detection, and contextual cross-matching. Two vectors are generated per user: user vector, one reflecting self-expression and partner vector, one for partner preference.

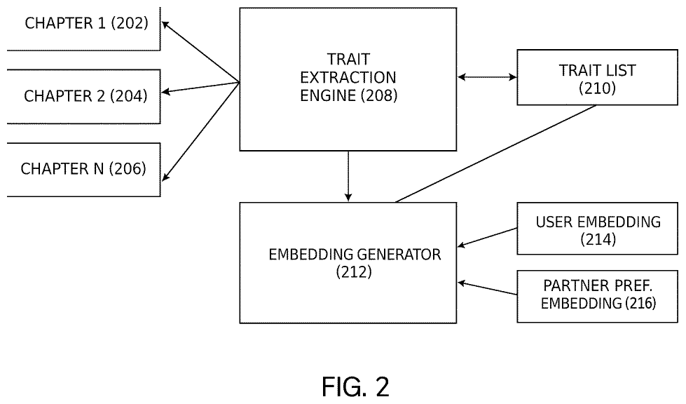

FIG. 3 is a schematic view of a Compatibility Engine Architecture module with dual scoring logic incorporating tone, context, and vector similarity, illustrating the AI for Humanity engine. Match scoring is computed bidirectionally and dynamically, using semantic similarity, tone alignment, and pattern congruence across themes.

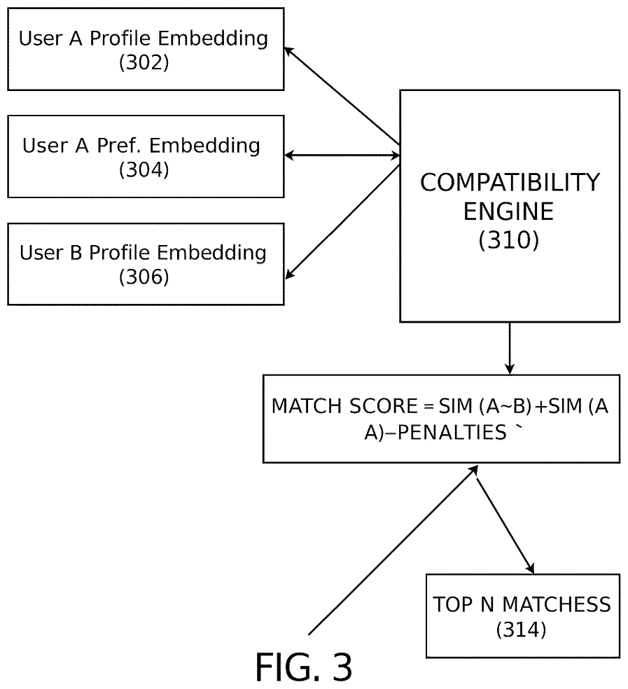

FIG. 4 is a schematic view of a Red Envelope Messaging System module with emotional pacing triggers and secure message handling, and illustrating the Red Envelope system, where milestone-based emotional messages can be sealed and unlocked only when predefined conditions are met.

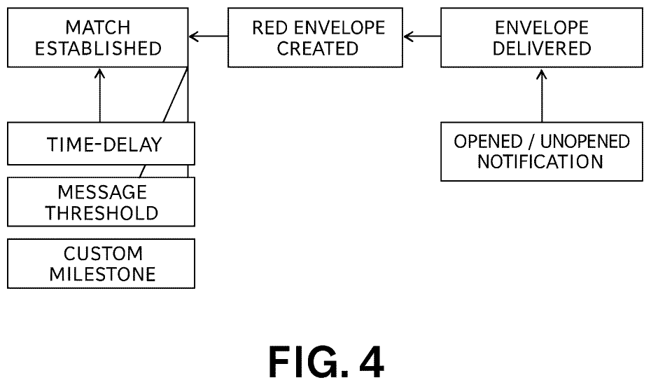

FIG. 5 is a high-level architecture flow illustrating user data input, security measures, and content processing for the matchmaking system.

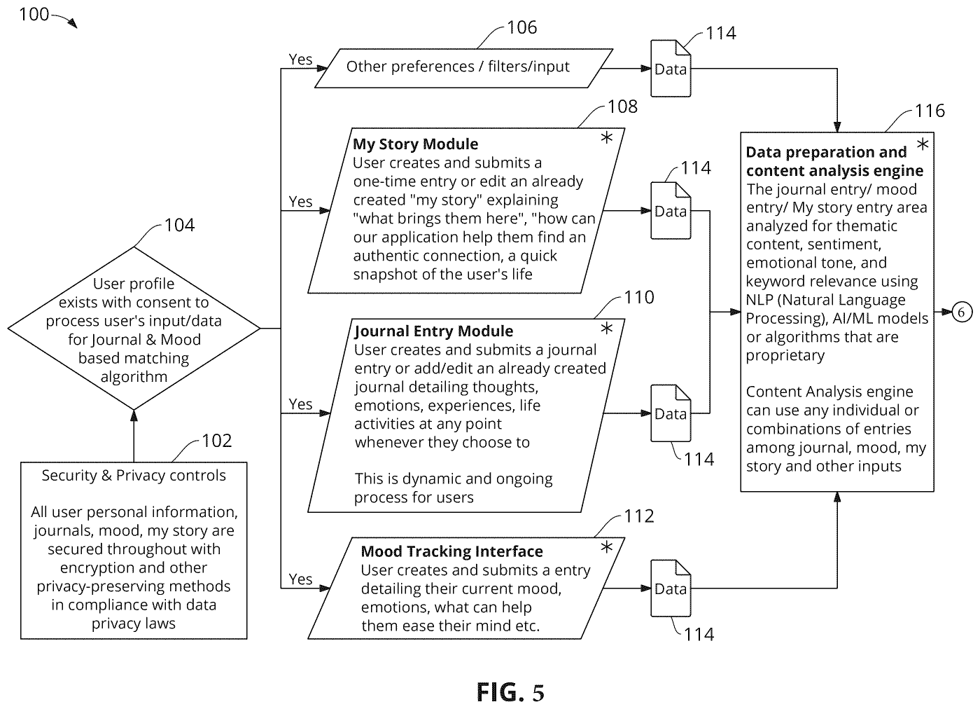

FIG. 6 is a continued high-level flow focusing on match criteria, feedback loops, and adaptive learning within the system, illustrating the user interface 10 and the first page tab 12, the second page tab 14, and the third page tab 16.

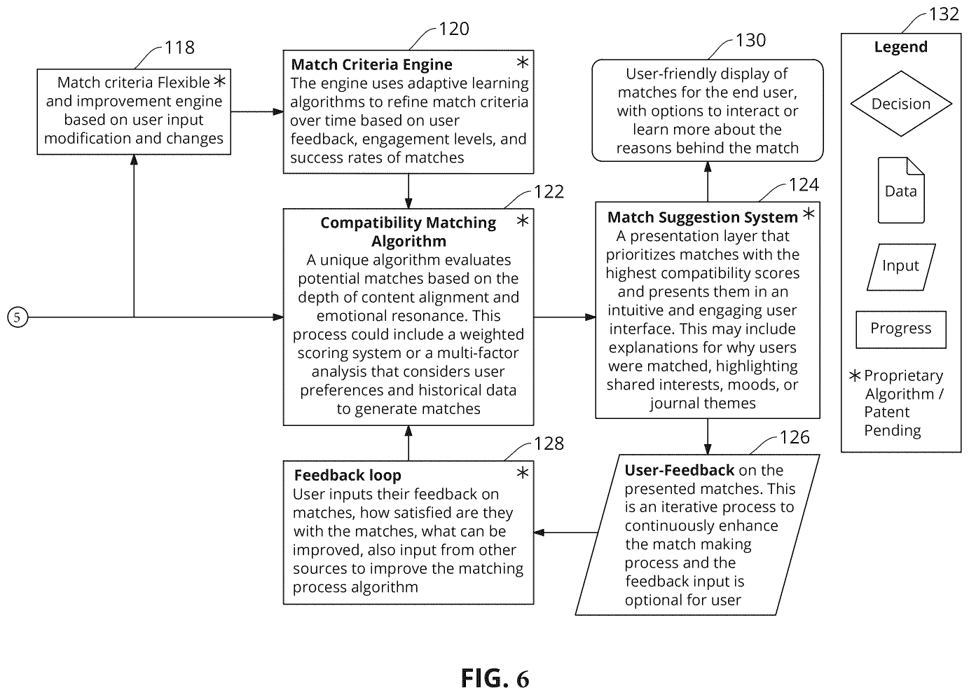

FIG. 7 is a schematic view of an exemplary embodiment of a user interface of the subject disclosure.

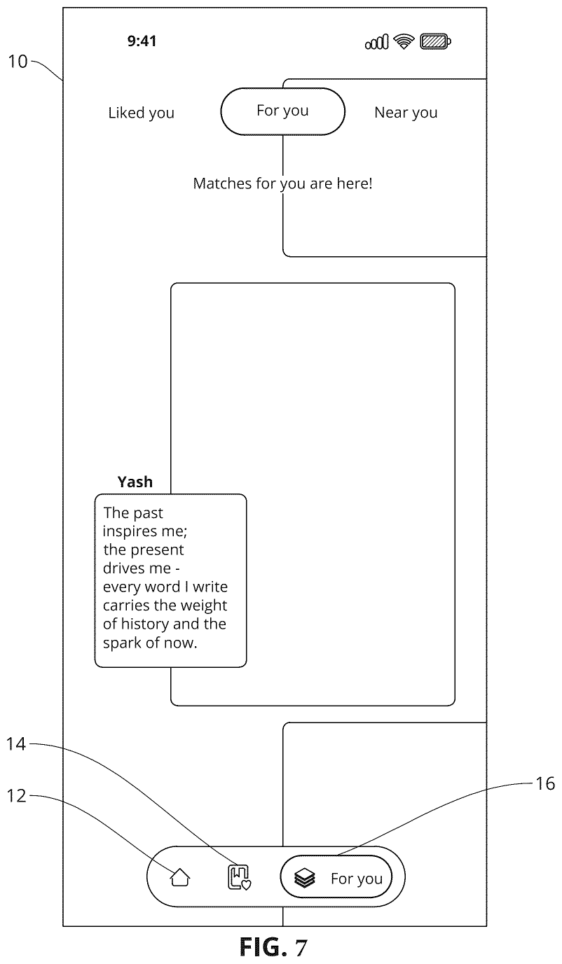

FIG. 8 is a schematic view of an exemplary embodiment of a user interface of the subject disclosure, showing the swiping action along the user interface 10, wherein a text box 18 and conversation area 20 is shown.

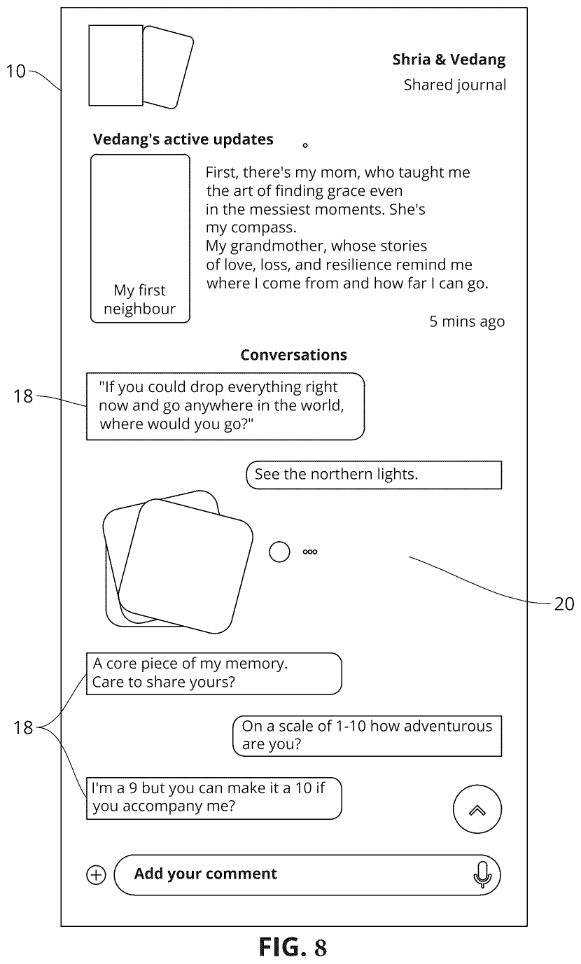

FIG. 9 is a schematic view of an exemplary embodiment of the user interface of the subject disclosure.

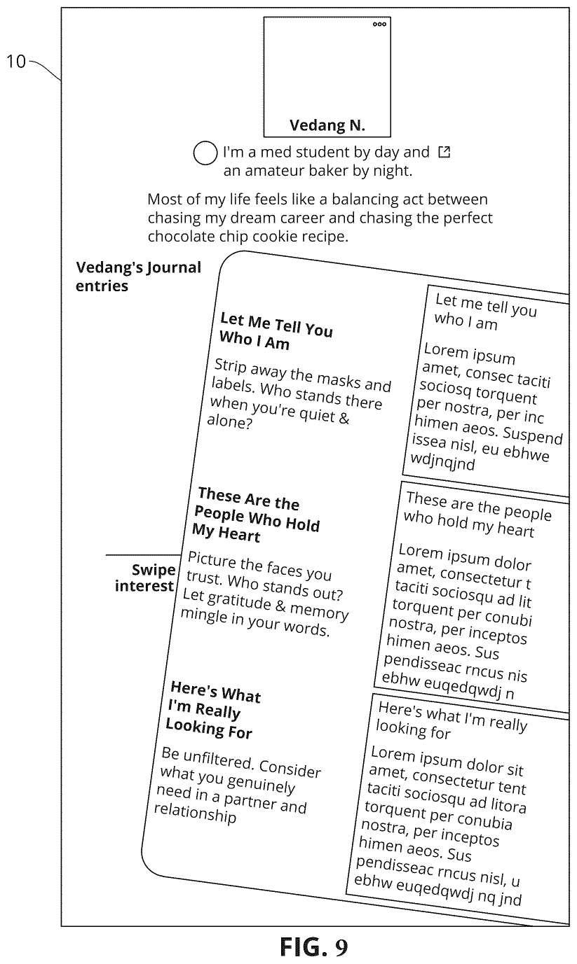

FIG. 10 is a schematic view of an exemplary embodiment of the user interface of the subject disclosure.

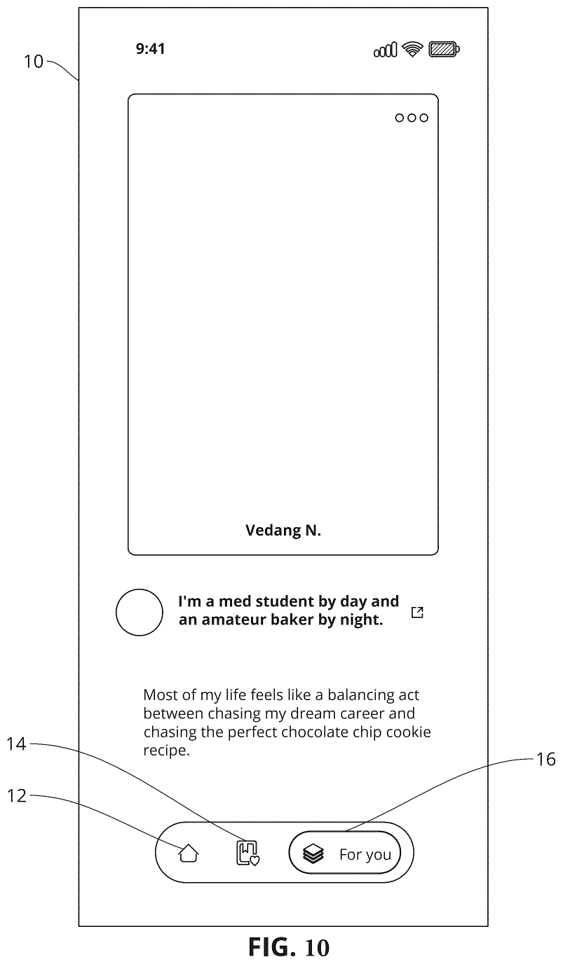

### BRIEF COMPONENT LIST

Reference numeral 100: User Profile & Consent—Ensures that each user grants permission for processing personal data (chapters, mood entries, My Story, etc.) under applicable privacy guidelines.

Reference numeral 102: Security & Privacy Controls—Applies encryption and other privacy-preserving methods to safeguard user information in compliance with data protection laws.

Reference numeral 104: Other Preferences/Filters/Input—Captures additional user settings or constraints (e.g., location preference, age range, certain deal-breakers) for refining matchmaking.

Reference numeral 106: Journal/Chapter Entry Module—Allows users to create or edit narrative-based entries (chapters or “journal pages”) describing thoughts, feelings, experiences, and personal reflections.

Reference numeral 108: My Story Module—A one-time or occasionally updated entry capturing the user's overarching personal story, motivations, or in-depth narrative.

Reference numeral 110: Mood Tracking Interface—Prompts users to log or update their current emotional state, complementing the chapter entries for dynamic compatibility scoring.

Reference numeral 112: Data Preparation & Content Analysis Engine—Performs NLP or AI-based parsing of user text for sentiment, thematic alignment, and other contextual cues, feeding results into the matchmaking algorithm.

Reference numeral 114: Aggregator/Ongoing Data Flow—Coordinates all incoming user inputs (journal entries, mood data, My Story updates) and prepares them for the next processing stage (e.g., the match criteria engine).

Reference numeral 116: Match Criteria Engine—Defines and updates the rules used to evaluate potential matches, based on factors such as emotional resonance and user preferences.

Reference numeral 118: Adaptive Learning/Improvement Module—Continuously refines match criteria over time by leveraging user engagement metrics, success rates of past matches, and other real-time insights.

Reference numeral 120: Compatibility Matching Algorithm—A proprietary mechanism that calculates overall alignment by comparing user traits (via journal/chapters, mood data) to partner preferences, factoring in narrative depth and tone.

Reference numeral 122: Feedback Loop—Collects user reactions, match acceptance/rejection, and satisfaction levels, feeding these data points back into the system for ongoing optimization.

Reference numeral 124: Output or Visualization Layer—Presents relevant explanations (e.g., why a match was suggested, which shared themes were detected) to enhance transparency for the user.

Reference numeral 126: Yes/No Decision Blocks or Additional Data—Handles branching logic or extra input points (such as gating advanced features or unlocking deeper match analyses).

Reference numeral 128: Checkpoint/Extended Data Flow—Further refines or reroutes match data, ensuring the system retains an iterative, real-time approach to matching.

Reference numeral 130: User Interaction/Confirmation Step—Allows the user to finalize match acceptance, apply extra filters, or initiate conversation with a suggested partner.

Reference numeral 132: Final Match Suggestions—Concludes the overall process by delivering refined matches to the user interface, enabling deeper engagement or immediate communication.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Referring now to the Figures, the subject disclosure may include the following systemic components:
1. Artificial Intelligence (AI) for Humanity—a proprietary AI Model (core system driving the platform) providing a context-aware AI framework designed to facilitate emotionally intelligent matchmaking, self-awareness, and self-growth. Core AI capabilities include Natural Language Processing (NLP) and Sentiment Analysis configured to extract values, emotions, and personality traits from user responses. In some embodiments, an optional Graph-Based Relationship Mapping is enabled to dynamically link user responses across chapters to track emotional growth and evolving compatibility. Multi-Agent Re-Ranking is contemplated, wherein filters and refinement matches are made based on AI-driven emotional intelligence, psychological alignment, and ethical constraints. A Dynamic Learning Mechanism module employs AI to adapt user recommendations over time, ensuring the matchmaking process reflects real-time changes in personality, intent, and emotional state.
2. AI-Based Chapter Recommendations and Insights (helping users understand themselves and others). The AI suggests which chapters a user should explore next, based on personal emotional patterns detected in previous responses. What has resonated most with other users in similar compatibility groups, thereby encouraging self-reflection and growth through structured storytelling prompts.
3. AI-Driven Compatibility Engine (deep, layered emotional matching) embodies a compatibility algorithm not based on static preferences but on evolving emotional patterns. The AI-Driven Compatibility Engine uses sentiment analysis and AI-driven personality profiling to extract emotional resonance from chapter responses. Reciprocal Matching Mechanism: Ensures mutual emotional alignment, rather than one-sided attraction. Adaptive Emotional Intelligence module adjusts compatibility scoring over time as users add new chapters, evolve, and reflect on past experiences.
4. AI-Powered Chapter Swiping Mechanism (intent-based matching, not appearance-based) enables, instead of swiping on full profiles or profile pictures, users to swipe on individual or multiple chapters that resonate with them. This creates multiple compatibility touchpoints, allowing for more granular alignment of relationship values. Progressive engagement, where deeper chapters unlock over time. Elimination of superficial, appearance-based decision-making.
5. Chapter-Based Profile Structure (guided self-discovery and emotional expression) provides, instead of writing free-form journal entries, users respond to predefined chapter prompts that help them articulate; essentially, who the user is beyond surface-level attributes: what they have learned from life experiences; how they view relationships, trust, intimacy, and long-term compatibility; what they seek in a partner and in life; and the like. Chapters are curated to encourage authenticity, emotional reflection, and progressive self-expression over time.
6. Dynamic Profile Evolution module (unlike traditional static profiles, this adapts in real-time) contemplates a user's book growing dynamically as they write new chapters. And so, the matching system continuously updates compatibility scoring based on the user's emotional growth, shifting relationship intent, and life reflections. AI learns from past swipes and chapter interactions, ensuring that matches remain relevant and emotionally aligned over time.
7. Emotional Distress Detection and Mental Well-Being Applications (beyond dating, real-world impact) charges AI to analyze patterns in user responses to detect signs of emotional distress, loneliness, or anxiety. The Emotional Distress Detection and Mental Well-Being Applications can integrate with mental health professionals, therapists, and hospitals to provide: Early intervention signals for emotional well-being support. Aggregate-level insights into mental health trends (without compromising privacy). A research-backed approach to social connection and individual well-being.
8. Multi-Modal User Interface (rich, expressive storytelling beyond text-based responses) supports text-based chapter responses for traditional storytelling. Voice notes, videos for expressive, emotional narration. Multimedia attachments (images, voice notes, videos and personal creative expressions).
9. Privacy and Security Controls (user-controlled visibility and AI-based safeguards) enable users to control which chapters are visible and to whom. AI moderates and flags sensitive content to prevent manipulation, coercion, or emotional exploitation. Privacy-first approach ensures users are not forced into sharing anything they are not ready to disclose.
10. Progressive Discovery System (unlocking depth over time, encouraging thoughtful engagement) selectively unveils users' access to an entire profile at once; instead, they unlock new chapters gradually, ensuring: i.e., trust and comfort are built progressively. Each stage of self-disclosure aligns with deeper compatibility filtering, whereby the system discourages immediate judgment and promotes intentional engagement.
11. Shared Writing/Journaling and Interactive Relationship Growth Component (post-match story evolution) provides wherein once matched, users can co-author a shared story, enabling relationship-building through guided storytelling. Encourages long-term relationship growth and deeper connection development rather than one-time interactions.
12. The Red Envelope Feature (intentional, time-sensitive emotional messaging system) facilitates a reserved message container available to users only after a match is formed. Unlike regular chat messages, Red Envelopes are designed for significant, emotionally meaningful moments. The system limits the number of Red Envelopes per user, making each envelope a scarce and valuable emotional currency. Examples of Red Envelope use include, but is not limited to, a message that a user hesitated to say in a live conversation; a timed or future-delivered message for birthdays, anniversaries, or relationship milestones; a deep emotional expression that a user wants to preserve as a “relationship treasure”; or the like. Technical innovations behind Red Envelope enable time-locked or event-based triggers, wherein a Red Envelope can be opened immediately or set to be unlocked on special occasions. Limited and non-replicable enablement has users get a set number of Red Envelopes, creating an emotional scarcity effect.
13. User Profile as a Book (a structured, progressive identity representation) is a functionality wherein each user is represented as a book, rather than a static profile. The book is structured into predefined chapters, each focusing on different aspects of the user's identity, values, emotions, and life philosophy. Unlike traditional profiles, users do not fill in generic bios—instead, they engage with structured prompts that guide meaningful self-expression.

The journal and story-based matchmaking system is an adaptive framework where users engage with predefined chapters representing their identity, values, and emotional journey. Instead of static profiles, users explore bundled or individual chapters, allowing for progressive engagement and evolving compatibility. Each component works interdependently to ensure intent-driven connections, self-growth, and emotionally intelligent matchmaking.
1. AI for Humanity—Proprietary AI Model The core AI system powering sentiment analysis, emotional intelligence, and compatibility insights. Connected to: (2) Processes user responses across chapters. (5) Determines compatibility from emotional themes. (10) Suggests relevant chapters based on user engagement. User Profile as a Book. Each user is a book, evolving through curated prompts that define identity, experiences, and values. Connected to: (3) Users respond to predefined chapters. (4) Users swipe on structured sets of chapters. (6) Profile dynamically updates with new chapters.3. Chapter-Based Profile Structure Users fill structured chapters instead of writing bios, grouped into: Self-awareness (identity, values, emotional growth). Relationship philosophy (trust, commitment, intimacy). Future vision (aspirations, long-term goals). Connected to: (5) AI analyzes emotional alignment across chapters. (8) Unlocks deeper chapters over time.4. AI-Powered Chapter Swiping Mechanism Users swipe on individual or bundled chapters to engage with meaningful themes. Connected to: (5) AI determines which chapter groupings contribute to compatibility. (8) Unlocks new chapters based on swiping behavior. 5. AI-Driven Compatibility Engine Uses sentiment analysis & NLP to assess user emotions and compute compatibility scores based on: Individual chapters, bundled sections, and overall book themes. Connected to: (6) Updates matches as new chapters are added. (7) Detects emotional distress (10) and suggests personalized chapter recommendations.6. Dynamic Profile Evolution User books evolve with new chapters, ensuring real-time matchmaking adjustments. Connected to: (4) AI dynamically adjusts matchmaking based on swipes. (8) Unlocks new book phases progressively.7. Emotional Distress Detection & Healthcare Applications AI detects distress patterns from language and emotional shifts, enabling potential mental health applications. Connected to: (5) Ensures emotionally mismatched users are filtered. (11) Protects user privacy in sensitive insights. 8.Progressive Discovery System Users unlock deeper chapters over time, ensuring relationships progress organically. Connected to:(3) Guides self-reflection through structured chapter prompts. (9) Enables deeper engagement post-match 9.Shared Journaling & Interactive Relationship Growth Matched users can co-author a shared story, strengthening connections through interactive storytelling. Connected to: (12) Supports voice and multimedia responses. (13) Enhances milestone-driven interactions with Red Envelopes.10. AI-Based Chapter Recommendations & Insights Suggests next chapters based on sentiment, engagement, and compatibility patterns. Connected to:(6) Updates recommendations as users evolve.11. Privacy & Security Controls Users control chapter visibility and emotional data sharing, ensuring ethical AI moderation. Connected to: (7) Protects emotional insights while enabling healthcare collaborations.12. Multi-Modal User Interface (Rich, Expressive Storytelling Beyond Text-Based Responses) Supports: Text-based chapter responses for traditional storytelling. Voice, video for expressive, emotional narration. Multimedia attachments (images, video, voice notes, and personal creative expressions).13. The Red Envelope Feature A reserved feature for emotionally significant messages with limited availability, making each message special. Connected to:(9) Strength.
1. Individual Component Functions for Humanity—Proprietary AI Model (Core System) Processes and interprets user responses, detecting sentiment, emotional depth, and personality traits. Continuously adapts compatibility scores as users add new chapters or modify existing ones. Ensures ethical matchmaking by filtering out manipulative or misleading behavioral patterns. User Profile as a Book (Structured Self-Expression) Users engage with predefined chapter prompts instead of writing free-form bios. The book structure allows for progressive storytelling, gradually revealing different life aspects. Chapter-Based Profile Structure (Guided Storytelling System) Users respond to guided prompts, covering self-awareness, relationship philosophy, and aspirations. Thematic alignment is tracked, ensuring users connect on shared values, not just preferences. AI-Powered Chapter Swiping Mechanism (Intent-Driven Matching) Users swipe on individual or bundled chapters, rather than full profiles. This ensures more precise compatibility alignment and prevents appearance-based selection bias. AI-Driven Compatibility Engine (Dynamic Emotional Matching) AI uses sentiment analysis & behavioral learning to refine compatibility scores over time. Reciprocal matching ensures both users align emotionally and intellectually before forming connections. Dynamic Profile Evolution (Real-Time Adaptation) As users add new chapters, AI updates their compatibility data. Profiles evolve dynamically, ensuring matches remain relevant over time. Progressive Discovery System (Gradual Engagement Unlocking) Users cannot access all chapters at once—this prevents information overload. Over time, new deeper chapters become accessible, allowing relationships to develop naturally. Shared Journaling & Post-Match Engagement (Relationship Growth Tools) Matched users can co-author shared chapters, reinforcing emotional connection. Encourages relationship-building beyond just initial attract The Red Envelope Feature (Intentional Emotional Messaging) A reserved feature for milestone-driven emotional messages, which remain locked until opened at the designated moment. This creates anticipation and deepens emotional investment. Privacy & Security Controls (User Protection Mechanisms) Users can control which chapters are visible and to whom. AI moderates content, ensuring ethical engagement and preventing manipulation. Multi-Modal User Interface (Enhanced Expression & Accessibility) Supports text-based storytelling, voice journaling or voice notes, and multimedia to enrich self-expression.2. How the Components Work Together to Perform the Desired Function AI for Humanity continuously processes user data, extracting deep emotional insights. The User Profile as a Book allows users to reveal themselves progressively, preventing information overload. The Chapter-Based Profile Structure organizes user input into curated, theme-based chapters, ensuring deep self-reflection. Chapter Swiping enables intent-based engagement, allowing users to interact with the aspects of a person's life that matter most to them. The AI-Driven Compatibility Engine analyzes patterns across chapters, adjusting match rankings based on evolving self-expression. Dynamic Profile Evolution ensures matches stay relevant as users grow and refine their personal narratives. The Progressive Discovery System unlocks new layers of engagement over time, ensuring a natural relationship-building process. Shared Journaling & Post-Match Engagement Tools promote deep, ongoing conversations beyond initial matching. The Red Envelope Feature allows users to send and receive milestone-driven, emotionally significant messages, deepening relational bonds. Privacy & Security Controls ensure safe, user-driven content visibility, making users feel comfortable sharing personal insights. The Multi-Modal User Interface enhances self-expression, allowing users to interact via text, voice, or visual storytelling.

Chapter Engagement & Profile Evolution Logic If a user engages with self-reflection chapters, AI prioritizes matches with similar traits. If a user writes a new chapter, AI updates compatibility based on new themes. If a user revisits or edits chapters, AI tracks evolving preferences and adjusts matches. If a user swipes right on emotional growth chapters, AI increases weight for emotionally intelligent matches. If a user skips deeper relationship-focused chapters, AI deprioritizes long-term compatibility-based matches. AI-Powered Chapter Swiping & Progressive Discovery Logic: If a user swipes right on bundled chapters, AI increases the likelihood of matching with others engaging in those themes. If a user swipes left on a chapter bundle, AI deprioritizes matches emphasizing those themes. If two users swipe on overlapping themes, AI elevates their match ranking. If a user completes early self-reflection chapters, AI progressively unlocks deeper relationship-building chapters. If a user frequently engages with self-growth chapters, AI suggests aspirational topics. If a user skips early foundational chapters but engages deeply with later ones, AI adjusts onboarding for emotional readiness. AI-Driven Compatibility Engine & Sentiment-Based AI Processing AI detects strong positive sentiment in early chapters, it prioritizes matches with similar optimism. If AI detects recurring negative sentiment across multiple chapters, it flags potential emotional distress while maintaining privacy. If a user strongly aligns with key emotional themes, AI suggests partners with shared resonance. If AI identifies major sentiment shifts over time, it recalibrates compatibility dynamically. If two users display opposite emotional tones in relationship chapters, AI deprioritizes that match. Post-Match Engagement & Relationship Growth Logic if a match is formed, AI unlocks deeper conversation prompts and shared writing.

A method of making the disclosure may include the following:
1. System Architecture & Tech Stack selection includes architecture that ensures scalability, adaptability, and AI-driven intelligence. Backend: Python (Fast API, Django)/Node.js (Express) Frontend: Android, IOS (Mobile) Database: MongoDB (document storage), Redis (real-time interactions) Vector Search & AI Models: FAISS, Pinecone, OpenAI GPT, Hugging Face Transformers Cloud Services: AWS Lambda, GCP Vertex AI, Azure AI2. AI-Driven Custom Embeddings & Compatibility Engine The core intelligence is powered by:2.1. Custom Embedding Generation Each user has two vectors: User Vector: Represents who they are (semantic meaning, values, emotional signals). Partner Preference Vector: Represents what they seek in a partner. Trait extraction: AI analyzes personality traits and self-expressions. Trait Parameterization (Frequency, Intensity, and Consistency): In one embodiment, the system further quantifies user traits by tracking frequency, intensity, and consistency across multiple chapters or mood entries: Frequency: How often a particular trait, keyword, or emotional theme appears in a user's chapter submissions. Intensity: The degree of emotional emphasis or sentiment strength associated with each trait (e.g., strongly positive, mildly negative). Consistency: Whether the user repeatedly expresses the same or related traits over time or across different categories/chapters, indicating higher stability of that trait.

These parameters are then aggregated or weighed to derive a more nuanced representation of each user's profile. For instance, a trait that frequently appears with high intensity across many chapters may be assigned a higher “confidence score” within the user's Self-Expression Vector. Conversely, traits mentioned sporadically or at low intensity might be weighted less. This helps the AI system capture both the breadth and depth of a user's personality, enabling more accurate compatibility predictions.

Graph-Based Representation (hereinafter ‘optional graph-based mapping’): In some embodiments, Users & Chapters are nodes, linked dynamically. Updates refine compatibility insights as new chapters are written.2.2. Reciprocal Matching Matches are bidirectional: Score A=User A's Partner Preferences vs. User B's Profile Score B=User B's Partner Preferences vs. User A's Profile Final Match Score=Weighted sum of reciprocal scores, semantic similarity, and clinical offsets.2.3. Clinical Offset & Ethical Matching If conflict styles mismatch, apply a clinical penalty to reduce compatibility ranking. If resilience and emotional stability align, add a clinical boost. The Ethics Agent reviews high-risk matches, ensuring safe recommendations.3. User Profile as a Book (Structured Story-Based Self-Expression) The profile is a dynamic book with structured, evolving chapters. Chapters Table stores: Core self-awareness (Who I Am, My Values, What I Seek) Emotional themes (Love, Growth, Aspirations) Partner preferences (Ideal traits, deal-breakers)

Necessary Elements (Core Functionality) These elements are essential for the system to function correctly, ensuring accurate compatibility matching, chapter-based engagement, and AI-driven personalization. AI for Humanity-Proprietary AI Model: This is the core intelligence that processes user responses, evaluates sentiment, and computes compatibility scores. Without this, the system would be incapable of making accurate predictions of matches. User Profile as a Book: Instead of static bios, the system organizes profiles into chapters that evolve over time. This is crucial for tracking personality development and relationship intent. Custom Embeddings & Compatibility Engine: This feature converts user data into vectorized representations, enabling accurate semantic matching and personalized recommendations. Graph-Based Relationship Mapping: The system organizes users and chapters as nodes in a graph, allowing for dynamic updates to compatibility scores as users add new content. Chapter Swiping & Engagement Tracking: Instead of swiping on entire profiles, users engage with chapter-based content, allowing for more refined, intent-based matching. Reciprocal Matching Logic: Matches must be validated bidirectionally, ensuring that compatibility is mutual rather than one-sided. Clinical Offset & Ethical AI Review: AI applies clinical adjustments to ensure emotionally safe and psychologically compatible matches, preventing harmful pairings. Dynamic Profile Evolution: As users add or update chapters, the system recalculates compatibility and adjusts matchmaking scores. Without these elements, the system would not function as intended. Optional Elements (Enhancements That Improve Experience) Progressive Discovery System, Shared Journaling, Red Envelope feature, multi-modal user interface, AI generated chapter suggestions.
1. Onboarding & Profile Creation The user signs up and starts building their profile, which is structured as a book composed of guided chapters.1.1. Initial Setup The user creates an account and selects relationship preferences (casual, serious, self-discovery).AI prompts the user to answer structured chapter questions, covering: Self-awareness (Who I Am, My Values, My Life Philosophy) Emotional & Relationship Themes (Love, Growth, Ideal Partner Traits) Future Goals (Aspirations, Relationship Expectations, Compatibility Must-Haves) AI processes responses, generating a unique profile embedding for personalized matchmaking.1.2. Adaptive Learning & Profile Evolution As users continue engaging with new chapters, AI dynamically updates their profile insights, refining: Compatibility rankings Sentiment-based emotional trends Relationship readiness & self-growth indicators2. Discovering Compatibility & Matching Process2.1. Chapter-Based Swiping & Intent-Based Discovery Instead of swiping on static profiles, users swipe on individual or bundled chapters based on themes that resonate with them. AI analyzes swiping patterns, detecting: Recurring interests in personality traits & relationship philosophies. Emotional alignment across multiple chapters, not just preferences. Skipped chapters, refining future recommendations to better match intent.2.2. AI-Driven Compatibility Matching AI retrieves, analyzes, and ranks potential matches based on: Semantic similarity between user chapters Reciprocal preference alignment Emotional & psychological compatibility Matches are context-aware, adjusting over time based on new chapter entries and evolving preferences.2.3. Progressive Discovery & Relationship Readiness Tracking AI unlocks deeper compatibility insights over time, ensuring: Users do not get overwhelmed with too much information too soon. Relationships develop organically, following natural emotional progression. If a match is highly compatible, AI recommends guided interactions to strengthen connection.3. Post-Match Engagement & Relationship Development3.1. Shared Journaling & Collaborative Storytelling Once matched, users gain access to shared journaling, allowing them to: Co-author chapters together Reflect on shared values and experiences Engage in structured storytelling, deepening emotional intimacy3.2. Red Envelope Feature (Milestone-Based Emotional Messaging) Users can send timed or milestone-driven messages, revealing them at significant moments. This feature creates anticipation and reinforces emotional connection over time.3.3. AI-Assisted Relationship Guidance AI tracks relationship sentiment shifts and engagement trends, providing: Suggestions for deeper conversations Reminders to revisit shared moments Encouragement for thoughtful interactions4. Privacy, Security, & Ethical AI Protections4.1. Data Protection & Access Control Users can control which chapters are visible and who can see them. AI moderates content for ethical engagement, preventing emotional manipulation.4.2. Mental & Emotional Well-Being Integration If AI detects emotional distress patterns, users receive: Gentle, AI-generated prompts for self-reflection. Guided journal entries to navigate emotions safely. Optional resources & support suggestions (while maintaining privacy).5. Long-Term Use & Continuous Refinement5.1. Ongoing Profile Evolution As users write more chapters and engage with the system, their AI-generated compatibility profile dynamically updates. The system ensures that matches remain relevant over time, reflecting emotional growth & evolving relationship needs.5.2. AI-Powered Relationship Insights Users receive periodic AI-generated insights on: Recurring emotional themes in their profile. Areas of relationship readiness & growth. Suggestions for refining their partner preferences.5.3. Once users develop a serious connection, the system.

Additionally, the subject disclosure, originally designed for AI-driven matchmaking, can be applied to other fields that require structured self-expression, emotional intelligence analysis, and compatibility-based recommendations.1. Alternative Use Cases Mental Health & Therapy→AI-guided journaling or chapter prompts for self-reflection, emotional tracking, and therapy support. Career Development→Matches professionals with mentors, teams, or workplaces based on personality fit. Education & Learning→Adaptive learning systems that track cognitive engagement & study habits through journaling or effective story telling. Friendship & Social Networks→Creates deep, meaningful friendships based on emotional compatibility. Self-Improvement & Coaching→AI-driven life tracking & personal growth recommendations.2. Adaptation for Technology Conversational AI→AI chatbots that guide users through emotional insights & decision-making. Blockchain & Web3→Secure identity & compatibility tracking for dating & social apps. Metaverse & VR→AI-powered relationship mentors & virtual emotional intelligence guides. Summary the subject disclosure can extend beyond matchmaking into mental health, career matching, education, and social networking, providing AI-driven self-reflection, compatibility insights, and structured emotional analysis

Also, the subject disclosure can produce multiple useful products, devices, and applications, extending its impact beyond matchmaking. While its primary function is AI-driven compatibility matching, its secondary outputs include structured emotional insights, personalized AI recommendations, and data-driven relationship intelligence.1. Primary Products & Outputs1.1. AI-Generated Compatibility Reports What It Is: The system produces detailed compatibility reports, summarizing: Emotional alignment Communication style Long-term compatibility projections Use Case: Can be offered as a premium feature for users seeking deeper relationship insights.1.2. Personalized AI Relationship Coach What It Is: A virtual relationship mentor that analyzes user data and provides: Communication tips Conflict resolution strategies Self-improvement exercises Use Case: Helps users strengthen emotional intelligence & relationship-building skills.1.3. Emotional Well-Being & Self-Discovery Tracker What It Is: AI-generated emotional growth summaries, tracking how users evolve over time. Use Case: Users receive personalized self-awareness insights, making it valuable for therapy, self-improvement, and coaching apps.2. Secondary Products & Possible By-Products2.1. AI-Powered Data Visualization Dashboards What It Is: AI-generated insights on relationship trends, emotional growth, and compatibility factors, visualized for users. Use Case: Can be integrated into mental health & social research platforms.2.2. AI-Generated Digital Personality Blueprint What It Is: A personalized digital map that represents a user's values, emotional strengths, and compatibility factors. Use Case: Can be licensed to career platforms, HR tools, or personal growth applications.2.3. Blockchain-Based Digital Identity for Secure Compatibility Matching What It Is: A decentralized, verified emotional profile, preventing identity fraud and fake profiles in dating/social network.

### In Another Embodiment of the Subject Disclosure:

1. User Profile Creation: This includes input fields for basic information, preferences, and the initial setup of the journal and mood tracking features.
2. Journal/Chapter Entry Module: A feature allowing users to create and maintain a digital journal/chapter entries within the app, with date and time stamps for each entry.
3. Mood Tracking Interface: An interactive interface for users to input their current mood, utilizing a range of emoticons, sliders, or textual descriptions.
4. Content Analysis Engine: Software algorithms designed to analyze journal or chapter entries, not only for thematic content, sentiment, and emotional tone, but also encompassing linguistic patterns, keyword relevance, and contextual understanding. This broader approach enables a dynamic and multifaceted analysis of user-generated content, ensuring a deeply personalized and nuanced understanding of each user's personality, experiences, and emotional landscape.
5. Mood Analysis Algorithm: Machine Learning algorithms that processes mood input data to determine patterns, fluctuations, and the prevailing emotional states of the user.
6. Compatibility Matching Algorithm: The core machine learning algorithm that integrates data from the journal or chapter responses and mood analysis components with traditional matching criteria (like interests and preferences) to identify potential matches.
7. Match Suggestion System: A system to present match suggestions to users, incorporating logic to prioritize suggestions based on the compatibility score generated by the matching algorithm.
8. User Interaction Interface: The interface through which users view match suggestions, interact with potential matches, schedule in-person meeting with them, and manage their journal or chapter responses and mood entries.
9. Feedback Loop: A feature for users to provide feedback on match quality and app experience, feeding into continuous improvement of the matching algorithm.
10. Security and Privacy Controls: Tools and settings that allow users to control the privacy of their journal or chapter entries and mood data, including options for what is shared with matches.
11. Notification System: A system to alert users to new matches, messages, and other relevant interactions within the app.
12. Data Storage and Management System: Backend databases and data management systems to securely store user profiles, journal or chapter entries, mood data, and match histories.
13. My Story is a module configured to prompt users for in-depth narrative-based input.

The relationship among the components of the journal or chapter responses and mood-based matchmaking system is designed to create a seamless, integrated experience for users while ensuring the depth and accuracy of matchmaking. Here's how these components interact, along with potential variations to consider for broader patent protection:

User Profile Creation (1) serves as the entry point where users provide initial information. This foundational step is crucial for establishing user identity and preferences, which are later enriched by data from Journal or Chapter Entry Module (2), Mood Tracking Interface (3), and “My Story” Module (13).

Journal or Chapter Entry Module (2) and Mood Tracking Interface (3) function as continuous data collection points, gathering nuanced personal insights over time. “My Story” Module (13) offers a one-time, in-depth narrative input (can change if needed) adding another layer of personal context.

Content Analysis Engine (4) and Mood Analysis Algorithm (5) process the data collected from steps 2 and 3. These analyses could potentially be performed in parallel or in a staggered manner, depending on the frequency and volume of data input. Variation in processing such as prioritizing mood data during periods of significant mood input or focusing on journal or chapter content analysis during active journaling or chapter writing phase could offer different matchmaking dynamics.

Compatibility Matching Algorithm (6) integrates processed data from the analysis engines (4 and 5) with the foundational user profile information (1), dynamically updating compatibility scores as new data becomes available. This step is central to the system, with flexibility in how data weights are adjusted based on user feedback (9) and interaction outcomes.

Match Suggestion System (7) utilizes compatibility scores to present potential matches to users. The logic here could vary, ranging from presenting matches in real-time as they are identified, to aggregating matches and presenting them at predetermined intervals. Alternating between these approaches could test user engagement levels and preference for match discovery pacing.

User Interaction Interface (8) and Notification System (11) facilitate engagement with match suggestions and the broader app functionality, serving as the user-facing components that enable interaction with generated matches and the monitoring of journal or chapter entries and mood updates.

Feedback Loop (9) captures user responses to matches and overall app experience, feeding this information back to the Compatibility Matching Algorithm (6) for continuous refinement. This component could also directly influence the Content Analysis Engine (4) and Mood Analysis Algorithm (5), suggesting an alternative flow where user feedback directly adjusts analysis parameters in addition to influencing match compatibility scoring.

Security and Privacy Controls (10) and Data Storage and Management System (12) underpin the entire system, ensuring user data integrity and privacy across all steps. The placement of these components is fixed in terms of operational necessity but could vary in terms of specific technological implementations and protocols.

### Alternative Configurations:

The sequence of Journal or chapter Entry Module (2) and Mood Tracking Interface (3) could be made interchangeable or even merged into a single, multifunctional module, allowing users to input mood states directly within journal or chapter entries for a more integrated data collection approach.

“My Story” Module (13), while initially positioned as a one-time input during profile creation, could be revisited periodically to capture evolving user narratives, offering a dynamic component to the profile that most systems lack.

The feedback mechanism (9) could be more directly integrated with the User Interaction Interface (8), allowing for real-time adjustments to the matching algorithm based on immediate user reactions to match suggestions.

Individual Functionality of the Systemic Components User Profile Creation (1) allows users to input basic personal information, preferences, and an introductory “My Story” narrative, laying the groundwork for personalized matchmaking.

Journal or Chapter Entry Module (2) enables users to document their thoughts, experiences, and emotions over time, serving as a rich data source for understanding their personality and current state of mind.

Mood Tracking Interface (3) provides a means for users to record their emotional states at various times, offering real-time data on their mood fluctuations and patterns.

“My Story” Module (13) offers a platform for users to share their motivations and expectations from the app, adding another layer of depth to their profile.

Content Analysis Engine (4) processes journal or chapter entries to extract thematic content, sentiment, and emotional tones, converting qualitative data into quantifiable insights.

Mood Analysis Algorithm (5) analyzes mood inputs to identify trends and significant mood states, further enriching the user's emotional profile.

Compatibility Matching Algorithm (6) integrates data from user profiles, journal or chapter analyses, and mood analyses to calculate compatibility scores between users, identifying potential matches based on a comprehensive understanding of emotional and psychological compatibility.

Match Suggestion System (7) utilizes compatibility scores to curate and suggest potential matches to users, prioritizing suggestions that have the highest likelihood of forming meaningful connections.

User Interaction Interface (8) serves as the user-facing component, where match suggestions are displayed, and users can interact with potential matches, manage their journal or chapter and mood inputs, and provide feedback on matches.

Feedback Loop (9) collects user responses to match suggestions and overall app experience, feeding this information back into the Compatibility Matching Algorithm (6) for continuous refinement and improvement. Security and Privacy Controls (10) ensure that users; personal data, especially sensitive journal entries or chapter entries and mood data, are protected, allowing users to control the visibility of their information and who it is shared with.

Data Storage and Management System (12) securely stores all user data, including profiles, journal or chapter entries, mood tracking data, and match histories, ensuring data integrity and availability for processing.

### Collective Functionality of the Systemic Components

The system begins with User Profile Creation (1), where initial user data is collected. As users engage with the Journal Entry or Chapter Entry Module (2) and Mood Tracking Interface (3), this data is continuously enriched and updated, providing a dynamic and evolving picture of each user.

The Content Analysis Engine (4) and Mood Analysis Algorithm (5) work in parallel to process this data, extracting actionable insights about users' emotional states, interests, and personality traits. This analysis is critical for understanding the nuances of each user beyond surface-level information.

These insights feed into the Compatibility Matching Algorithm (6), which calculates compatibility scores based on a holistic view of each user, considering emotional, psychological, and interest-based factors. The algorithm's dynamic nature allows for real-time adjustments based on new data ensuring that match suggestions remain relevant and reflective of users' current states.

Match Suggestion System (7) then presents users with potential matches, facilitated by the User Interaction Interface (8), which also serves as a platform for users to interact with the system and provide feedback through the Feedback Loop (9).

Security and Privacy Controls (10) and Data Storage and Management System (12) ensure that throughout this process, user data is protected to maintain user trust and system integrity.

The systemic architecture is designed with flexibility, allowing for future enhancements ensuring it remains at the forefront of matchmaking:

### User Data Analysis Logic

Journal or Chapter Entry Analysis: If a new journal or chapter entry is detected—Then analyze the entry for emotional tone, thematic content, and sentiment. If specific emotional keywords or phrases are identified—Then update the user's emotional profile to reflect these insights.

Mood Tracking Analysis: Every time a user updates their mood the subject disclosure may calculate the average mood score over the last week. If the current mood significantly deviates from the average—then the system may flag for potential impact on matchmaking recommendations. Compatibility Assessment Logic

Matchmaking Algorithm: For each potential match, by way of a non-limiting examiner, if users share common themes in journal or chapter entries and their mood data aligns, then there is an increased compatibility score. If compatibility score exceeds a predetermined threshold—Then suggest users as potential matches to each other.

Dynamic Matching Adjustment: If a user consistently ignores matches with a certain trait, then an adjustment may be done by the algorithm to deprioritize that trait in future matches. If a user frequently interacts positively with matches sharing a specific interest, then the system may increase the weight of that interest in compatibility assessment.

### Feedback Loop Logic

User Feedback Analysis: If a user rates a match positively, then the system may reinforce the matching criteria that led to this match. If negative feedback is received, then the algorithm may identify the negative correlation and adjust the matching parameters that may have led to the unsatisfactory match.

### Subroutines and Modules

Content Analysis Engine: A subroutine that takes journal or chapter entries as input and outputs analyzed data including sentiment scores, identified interests, and emotional states.

Mood Analysis Module: A subroutine that processes mood inputs to update user profiles with current emotional states, detecting patterns or significant changes over time.

Important Elements and Steps of the present invention include the following:

Development of the User Interface (UI), including designing and implementation of a user-friendly interface for User Profile Creation (1), Journal or Chapter Entry Module (2), Mood Tracking Interface (3), and “My Story” Module (13). The UI should be intuitive and encourage user engagement.

Creation of the Content Analysis Engine (4), including developing machine learning algorithms, Generative AI, AI Models, Retrieval Augmented Generation (RAG) architecture, Natural Language Processing, Vector Searches, Embedding Models capable of processing natural language to extract thematic content, sentiment, and emotional tone from journal or chapter entries. Use machine learning techniques to improve accuracy over time based on user feedback and additional data.

Development of the Mood Analysis Algorithm (5) includes implementing machine learning algorithms, Generative AI, AI Models, Retrieval Augmented Generation (RAG) architecture, Natural Language Processing, Vector Searches, Embedding Models to analyze mood data input by users, identifying patterns and significant emotional states. This should include the ability to adjust mood profiles dynamically.

Compatibility Matching Algorithm (6), including creation a sophisticated machine learning algorithm, Generative AI, AI Models, Retrieval Augmented Generation (RAG) architecture, Natural Language Processing, Vector Searches, Embedding Models that integrate data from the journal and mood analysis with traditional matching criteria. This algorithm should dynamically calculate compatibility scores and adapt based on ongoing user interaction and feedback.

Match Suggestion System (7) and User Interaction Interface (8), including development of a system to present match suggestions to users and allow them to interact with these suggestions. Include features for users to accept, reject, or communicate with potential matches.

Feedback Loop (9), including implementation of a mechanism for collecting user feedback on match suggestions and overall app experience. This feedback should directly influence future match suggestions and algorithm adjustments.

Security and Privacy Controls (10), including establishing robust security measures to protect user data, including encryption for data storage and transmission. Provide users with privacy controls for their journal or chapter entries and mood data.

Data Storage and Management System (12), setting up databases to securely store user profiles, journal or chapter entries, mood tracking data, and match histories. Ensure scalability, high availability to accommodate growth and resilience.

User Profile Creation (1): Essential for gathering initial user information and preferences, serving as the foundation for personalized matchmaking.

Journal or chapter Entry Module (2): Critical for allowing users to document their thoughts and experiences, providing deep insights into their personality and emotional state.

Mood Tracking Interface (3): Vital for capturing real-time emotional data from users, enriching the profile with current mood states.

Content Analysis Engine (4): Necessary for processing journal or chapter entries to extract meaningful data such as thematic content, sentiment, and emotional tone.

Mood Analysis Algorithm (5): Required to analyze mood data, identifying patterns and significant emotional states that impact compatibility.

Compatibility Matching Algorithm (6): The core element that integrates data from the content and mood analysis with user preferences to identify potential matches.

Match Suggestion System (7): Essential for presenting users with potential matches based on the compatibility scores calculated by the algorithm.

User Interaction Interface (8): Crucial for facilitating user engagement with the system, including managing their profile, journal or chapter entries, mood inputs, and interacting with match suggestions.

Feedback Loop (9): Necessary for collecting user feedback on matches, which is used to refine and improve the matching algorithm.

Security and Privacy Controls (10): Fundamental for ensuring the protection of user data, especially sensitive journal or chapter entries and mood information.

Data Storage and Management System (12): Required to securely store and manage user data, including profiles, journal or chapter entries, mood tracking data, and interaction histories.

### Elements for Improvement:

Further optimization of Artificial Intelligence (AI)-Driven Insights

Behavioral Analytics Module: Analyzing user behavior within the app could offer insights for further refining the matching algorithm.

Interchangeable Data Analysis Modules: The Content Analysis Engine (4) and Mood Analysis Algorithm (5), while sequentially distinct, could be reconfigured to operate in parallel rather than in a linear sequence. This means that journal or chapter entries and mood data could be analyzed simultaneously to expedite the matchmaking process, rather than first completing journal or chapter entries analysis followed by mood analysis.

Dynamic Integration of “My Story” Module (13) with Journal or Chapter Entries: The “My Story” Module, initially a separate component for narrative input, could be integrated directly into the Journal or Chapter Entry Module (2). Users could be prompted to update their “My Story” as part of their regular journaling or Chapter writing, making the process more dynamic and reflective of ongoing personal growth.

Modular Compatibility Analysis: The Compatibility Matching Algorithm (6) could be designed to function modularly, where various sub-algorithms or components (e.g., analyzing hobbies, values, emotional states) operate independently and can be re-ordered or weighted differently based on user feedback or observed success rates. This modular approach allows for the customization of the matching process to prioritize different compatibility factors as needed.

Feedback Loop Direct Integration: Instead of the Feedback Loop (9) functioning as a separate step after match suggestions, feedback mechanisms could be integrated directly into the User Interaction Interface (8), allowing users to provide immediate feedback within the context of each interaction. This could streamline the process of collecting and applying insights to refine the matching algorithm.

Swapping Match Suggestion and User Interaction: The Match Suggestion System (7) and User Interaction Interface (8), while sequentially presented, could be conceptually swapped. For example, users could first be brought into an interactive community space or forum (part of the User Interaction Interface) where match suggestions are organically integrated.

To use the journal or chapter writing and mood-based matchmaking system to solve the problem of superficial digital connections and foster meaningful relationships, follow these detailed steps. This guide functions as a brief “owner's manual” for implementing and utilizing the invention effectively:

### Step 1: User Profile Creation

Users begin by creating a profile (1), entering basic personal information, preferences, and a narrative in the “My Story” Module (13). This narrative allows users to express their motivations for joining the platform and what they seek in connections.

### Step 2: Journaling or Chapter Writing and Mood Tracking

Users are encouraged to regularly use the Journal or Chapter Entry Module (2) to document their daily thoughts, experiences, and emotions. This practice provides a rich, qualitative dataset for analysis.

Concurrently, users input their current emotional state via the Mood Tracking Interface (3), offering quantitative emotional data that complements the journal or chapter entries.

### Step 3: Data Analysis

The Content Analysis Engine (4) processes journal or chapter entries to identify thematic content, sentiment, and emotional tone, transforming qualitative journal or chapter data into quantifiable insights.

Simultaneously, the Mood Analysis Algorithm (5) evaluates mood data to detect patterns and significant emotional states, enriching the user's emotional profile.

### Step 4: Compatibility Matching

The Compatibility Matching Algorithm (6) integrates insights from the content and mood analyses with the foundational user profile information. This algorithm calculates compatibility scores between users by considering a broad spectrum of compatibility factors, including shared interests, life philosophies, and emotional resonance.

### Step 5: Match Suggestions

Based on the compatibility scores, the Match Suggestion System (7) curates and presents users with potential matches. This system prioritizes suggestions that have the highest likelihood of fostering meaningful connections. Step 6: Interaction and Feedback

Through the User Interaction Interface (8), users view match suggestions, manage their journal or chapter and mood inputs, and interact with potential matches. Users can accept, reject, or communicate with their matches to explore potential connections.

Users provide feedback on the quality of matches via the Feedback Loop (9), influencing future match suggestions and allowing for continuous refinement of the matching algorithm.

### Step 7: Security and Privacy Management

Users configure their Security and Privacy Controls (10) to manage the visibility of their journal or chapter entries, mood data, and personal information, ensuring a comfortable and safe user experience.

### Step 8: Continuous Engagement

Users are encouraged to continuously engage with the system by updating their journal or chapter and mood data, interacting with match suggestions, and refining their profile preferences. This ongoing engagement ensures that the system remains dynamic and responsive to the user's evolving emotional landscape and relationship goals.

### Owner's Manual Notes:

This system is designed to dynamically adapt to each user's unique emotional journey, offering a personalized matchmaking experience that evolves with the user.

Regular engagement with the journaling or chapter entries and mood tracking features enriches the user's profile and improves the accuracy and relevance of match suggestions.

Feedback is a critical component of the system, allowing users to directly influence the matching process and ensuring that the platform continuously evolves to meet user needs more effectively.

Additionally, the journal, chapter responses and mood-based matchmaking system has potential applications beyond digital matchmaking, adaptable across various sectors:

Mental Health Applications: Utilize the system for monitoring mental well-being, identifying emotional distress patterns, and suggesting interventions in teletherapy or wellness apps, offering personalized emotional support.

Educational Tools: Adapt the methodology to track students' emotional engagement with learning materials, enabling personalized educational experiences to enhance satisfaction and outcomes.

Customer Insights for Businesses employing the system in CRM to analyze customer feedback for trends in satisfaction, aiding in tailored marketing and support strategies.

### Personalized Content Recommendations

Streaming services can leverage mood and emotional state analyses to offer users content recommendations that match their current feelings, enhancing user experience.

Workplace Wellbeing includes implementing the system within organizations to monitor employee morale through mood check-ins, informing management strategies and fostering a supportive work environment.

Technological Implementation wherein the system's adaptability for emotional and textual data analysis makes it a valuable tool for software solutions in any industry seeking to understand human emotions, with potential for computer or machine implementation to automate processes.

Also, the present invention can create emotional Behavior Insights: The system's data analysis can offer deep insights into emotional patterns and trends, serving as a valuable resource for psychologists, sociologists, and market researchers looking to understand the complexities of human emotion and behavior in the digital age.

Mental Health Monitoring Tools: By tracking journal or chapter entries and mood fluctuations, the system can help create comprehensive monitoring tools for users and mental health professionals. These tools can assist in recognizing patterns that may indicate emotional distress or mental health issues, facilitating early intervention.

Educational Engagement Reports: The analysis capabilities of the system can be used to generate reports on how students engage emotionally with educational content. This can aid educators in tailoring teaching methods and materials to better suit students' emotional and learning needs, potentially enhancing educational outcomes.

Customer Sentiment Analysis: Businesses can leverage the system's sentiment analysis features to gain insights into customer preferences, satisfaction levels, and overall market trends. This information can inform product development, marketing strategies, and customer service improvements.

Content Personalization Engines: For content providers, the system's mood analysis feature can be adapted to create sophisticated content personalization engines. These engines can recommend movies, music, articles, and other content based on the current mood of the user, enhancing user experience and engagement.

Workplace Wellbeing Indexes: Organizations can use the system to develop indexes or reports that gauge the overall emotional well-being and morale of employees. Such insights can guide efforts to improve workplace culture, implement supportive policies, and foster a more positive and productive work environment.

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, Mac-OS, Windows, Unix, OpenVMS, an operating system based on Linux, or any other appropriate operating system, including future operating systems. In some embodiments, the computing systems may be a web server running web server applications such as Apache, Microsoft's Internet Information Server™, and the like.

In particular embodiments the computing systems include a processor, a memory, a user interface and a communication interface. In particular embodiments the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example, and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory May include removable or non-removable (or fixed) media, where appropriate. The memory may be internal or external to computing system, where appropriate. In particular embodiments the memory is non-volatile, solid-state memory.

The user interface may include hardware, software, or both providing one or more interfaces for communication between a person and the computer systems. As an example, and not by way of limitation, a user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface.

The communication interface includes hardware, software, or both providing one or more interfaces for communication (e.g., packet-based communication) between the computing systems over the network. As an example, and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the subject disclosure and that modifications may be made without departing from the spirit and scope of the subject disclosure as set forth in the following claims.

What is claimed is:

1. A matchmaking system comprising
an interface operable to:
electronically receive a plurality of user profiles, each profile structured as a digital book comprising one or more thematic categories with multiple chapters of a respective user; and
electronically receive a first request for matching, wherein the first request for matching corresponds to a prompt or an action by said first user to retrieve recommended matches via the interface,
a processor coupled to the interface and operable to:
determine from the plurality of user profiles a set of preferred partner characteristics for the first user by way of a progression module based on chapter completion thresholds;
cause the display of a graphical representation of a preferred partner matched based on the set of preferred partner characteristics of the first user on a graphical user interface of the first electronic device, the preferred partner corresponding to one or more thematic categories and relevant digital book chapters of a second user; and
wherein the interface is further operable to receive from the first electronic device of the first user a first positive preference indication associated with the graphical representation of the second user on the graphical user interface, the first positive preference indication associated with a swiping gesture performed on the graphical user interface, wherein the gesture comprises a swiping gesture of the one or more thematic categories and relevant digital book chapters of the second user.

2. The matchmaking system of claim 1, wherein the processor is further operable so that each chapter supports at least three or more expressive response formats selected by the user.

3. The matchmaking system of claim 1, wherein the processor is further operable to provide a compatibility engine that extracts emotional traits from user responses using natural language understanding and tone analysis, wherein the set of preferred partner characteristics is augmented by the extracted emotional traits.

4. The matchmaking system of claim 3, wherein said compatibility engine creates a user vector representing a user's expressed traits and a partner vector representing the user's preferred partner characteristics.

5. The matchmaking system of claim 4, wherein compatibility scoring is calculated bidirectionally by comparing each user's preference vector to the other user's trait vector.

6. The matchmaking system of claim 4, wherein compatibility scoring incorporates narrative depth, tone resonance, and expressive pattern analysis of the digital book of the matched preferred partner.

7. The matchmaking system of claim 1, wherein the processor is further operative to gate or limit access to subsequent chapter categories based on minimum threshold completions from prior categories.

8. The matchmaking system of claim 1, wherein the processor is further operable to enable users to evaluate and select preferred partner matched by interacting with individual or bundled chapters.

9. The matchmaking system of claim 8, wherein the processor is further operable to provide swiping feedback updates to said compatibility vectors and thematic interest models.

10. The matchmaking system of claim 1, wherein the processor is further operable to comprise a red envelope messaging feature that enables milestone-based emotional communication governed by predefined triggers.

11. A method for matchmaking, comprising:
(a) receiving user inputs structured as one or more chapters of a digital book;
(b) analyzing said chapters via a large language model to extract emotional or personality traits;
(c) storing said traits in a data structure comprising a list or graph-based data structure;
(d) generating a user vector and a partner vector for each user;
(e) comparing user vector of a first user with partner vector of a second user to compute a bidirectional compatibility score; and
(f) displaying a recommended match to the first user, wherein the recommended match is a function of said bidirectional compatibility score.
